(19) United States
(12) Patent Application Publication
(10) Pub. No.: US 2025/0381753 A1
(43) Pub. Date: Dec. 18, 2025

(54) INSTALLATION FOR PRODUCING CORRUGATED PAPERBOARD, AND METHOD FOR OPERATING SUCH AN INSTALLATION

(71) Applicant: BHS Corrugated Maschinen- und Anlagenbau GmbH, Weiherhammer (DE)

(72) Inventors: Simon Huber, Amberg (DE); Dominic Meier, Wernberg-Köblitz (DE); Julian Messer, Pfreimd (DE); Tim Slawik, Bayreuth (DE)

(21) Appl. No.: 18/877,689

(22) PCT Filed: Jul. 26, 2023
(86) PCT No.: PCT/EP2023/070670

§ 371 Date: Dec. 20, 2024

(30) Foreign Application Priority Data
Jul. 29, 2022 (DE) 10 2022 207 858.6

(51) Int. Cl. B31F 1/28; B31B 50/88; B41F 19/00; B41F 23/00

(52) U.S. Cl. CPC B31F 1/285; B31B 50/88; B41F 19/00; B41F 23/007

(57) ABSTRACT

The invention specifies a method for operating an installation (2), wherein the installation (2) has a corrugator (4) for producing corrugated paperboard (6), wherein the installation (2) has a printing installation (8) for printing a print on a paper ply (10), wherein the installation (2) has a thermal engine (12) for generating thermal power (Pth) and electrical power (Pel), wherein the corrugator (4) and the printing installation (8) form a combination and are thus jointly supplied with thermal power (Pth) and with electrical power (Pel) 10 by the thermal engine (12). The invention also specifies a corresponding installation (2).

The invention relates to a method for operating an installation which is designed to produce corrugated paperboard, as well as to a corresponding installation.

During the production of corrugated paperboard, a plurality of paper plies is joined by means of a corrugator to form a corrugated paperboard web and then optionally assembled. For example, in order to produce double-layered (or two-part) corrugated paperboard, two paper plies are each corrugated using a corrugating roller and then alternately glued to form a stack with three non- corrugated paper plies. The corrugated paperboard web is then assembled and cut into individual panels, for example. During the production of corrugated paperboard, energy is required in the various processing stations of the corrugator. On the one hand, electrical power (electricity) is required to drive the corrugator and, on the other hand, thermal power (heat) is required for drying or steam generation at various points, e.g. when producing a corrugated paper web by means of a corrugating roller. The requirement for thermal power usually significantly exceeds the requirement for electrical power.

In principle, it is desirable to make the production of corrugated

paperboard as energy-efficient and cost-effective as possible and to use as fully as possible the primary energy used to operate the corrugator. The concept of combined heat and power (CHP) or even combined cooling, heat and power (CCHP) generally offers the advantage that in an integrated process the primary energy used (e.g. natural gas) is basically fully converted not only into heat but also into electricity and can therefore be used efficiently. However, the ratio of electrical power to thermal power achieved here cannot be adjusted as desired, but is determined by the conversion process of the primary energy, so that an CHP or CCHP is not necessarily best suited for every process.

Against this background, it is an object of the invention to make the production of corrugated paperboard as energy-efficient as possible. In particular, an CHP process or even an CCHP process is to be used here. For this purpose, a correspondingly improved installation for producing corrugated paperboard and a method for its operation are to be specified.

The object is achieved according to the invention by a method having the features according to claim 1 and by an installation having the features according to claim 18. Advantageous embodiments, further developments, and variants are the subject of the dependent claims. The statements in connection with the method also apply analogously to the installation, and vice versa. If steps of the method are described below, expedient embodiments of the installation result from the fact that the installation is designed to carry out one or more of these steps. For this purpose, the installation has in particular a correspondingly designed control unit.

A core idea of the invention is in particular to combine a corrugator with a printing installation and then to operate these together with a thermal engine. In other words, a corrugator, a printing installation and a thermal engine are energetically coupled with one another. This is based on the knowledge that the ratio of thermal power to electrical power (i.e. the power ratio) of a thermal engine optimally reflects the total thermal and electrical power requirements of a corrugator in combination with a printing installation. In contrast, a thermal engine is not suitable for supplying only a printing installation or only a corrugator, since their respective power requirement ratio (ratio of thermal to electrical power requirement) does not correspond to the power ratio of the thermal engine.

The method according to the invention serves to operate an installation. The installation has a corrugator for producing corrugated paperboard. The corrugated paperboard is produced, for example, as a continuous corrugated paperboard web or as a ready-made panel. The installation also has a printing installation for printing a print on a paper ply, in particular by means of a print head. In particular, the printing installation and the corrugator are operated simultaneously. The paper ply is preferably used to produce the corrugated paperboard and is transferred from the printing installation to the corrugator, but this is not mandatory. Printing is preferably carried out before the paper ply is further processed, in particular before it is combined with other paper plies to form corrugated paperboard. Alternatively, the paper ply is printed on when it has already been combined with one or more other paper plies. The printing installation is preferably a digital printing installation; this is assumed below without loss of generality, although other printing installations are also suitable in principle.

Overall, the installation is used in an advantageous embodiment to produce printed corrugated paperboard. The printing installation and the corrugator are preferably operated in-line (in-line operation), i.e. the paper ply that is printed on passes through the printing installation and the corrugator without being wound up and unwound in between. With regard to controlling the conveying speed, the printing installation preferably follows the corrugator, i.e. the corrugator specifies a conveying speed which is then adopted by the printing installation. The conveying speed varies, in particular depending on the current production order for the installation, so that the thermal and electrical power requirements may also vary within certain limits.

As an alternative to the in-line operation specified, an embodiment is also suitable in which the printing installation and the corrugator are operated separately from one another, i.e. the paper ply is not directly transferred to the corrugator and, in one possible embodiment, is even used elsewhere and not further processed in the corrugator. For example, the printing installation and the corrugator produce a printed paper ply on the one hand and corrugated paperboard on the other completely independently of one another. In a suitable embodiment, the printing installation is operated in a roll-to-roll mode, i.e. the paper ply is unrolled at entrance into the printing installation, then printed on with the printing installation, and finally rolled up into a roll again at the end of the printing installation. This roll is then transferred to the corrugator and unrolled there in order to produce corrugated paperboard therefrom, or the roll is used for something completely different, e.g. in another corrugator. Alternatively or additionally, the corrugator is operated in a roll-to-sheet mode. In any case, the respective conveying speed of the printing installation and/or of the corrugator varies regularly, depending on the current production order, so that the thermal and electrical power requirements may also vary within certain limits.

The installation also has a thermal engine for generating thermal and electrical power. The thermal engine preferably has a gas turbine and in particular also a generator. The gas turbine is operated with gas as the primary energy source (i.e. chemically supplied primary energy) and, when it is burned, generates predominantly thermal power on the one hand and mechanical power on the other, which drives the generator, which then generates electrical power. In the following, without loss of generality, a gas turbine with a generator is assumed, but other thermal engines are also suitable in principle. Preferably, only a single primary energy source is used for the entire installation, with the smallest possible carbon footprint (e.g. SNG, biogas or green hydrogen).

The corrugator and the printing installation now form a combination and are thus jointly supplied with thermal power and electrical power by the thermal engine, i.e. the thermal and electrical power generated by the thermal engine are distributed between the corrugator and the printing installation. Both the corrugator and the printing installation each consume not only thermal but also electrical power. As already indicated above, it is of secondary importance whether the printing installation and the corrugator are operated in-line or separately from one another. What is initially important is only that the combination of printing installation and corrugator is jointly supplied with both thermal and electrical power by the thermal engine.

A significant advantage of the invention is that the power requirement ratio of the combination of corrugator and printing installation corresponds particularly well to the power ratio of the thermal engine. When the printing installation and the corrugator are operated simultaneously, their thermal and electrical power requirements are combined and can then be served jointly by a single thermal engine as described. By combining the corrugator with the printing installation, the disadvantage that they, when considered alone, are difficult to use in an CHP or CCHP process is eliminated. For example, it has been observed that a gas turbine has a power ratio of approximately 2:1 (e.g. 3.7 MW thermal and 1.8 MW electrical), while a corrugator typically has a power requirement ratio of approximately 10:1 (e.g. 2.5 MW thermal and 250 KW electrical) and a printing installation typically has a power requirement ratio of approximately 1:1 (e.g. 1 MW each thermal and electrical). In combination, however, this results in a power requirement ratio of around 2.8:1, so that the use of an CHP or CCHP process is particularly cost-effective in a combination of corrugator and printing installation. Accordingly, the thermal engine has a corresponding ratio of thermal to electrical power, wherein a small deviation from the ideal ratio is tolerated, in particular if there is a surplus of electrical power, since this can be particularly easily discharged into a grid. Accordingly, a thermal engine with a power ratio of 2:1 to 3:1 (thermal to electrical) is already advantageous. As will be explained in more detail below, the power requirement ratio of the combination can still be adjusted within certain limits, so that further optimization and approximation to the power ratio of the thermal engine is possible. This results in a significant increase in efficiency compared to the separate operation of the corrugator and the printing installation, since the CHP/CCHP process achieves maximum use of the chemical primary energy. There is also a reduction in operating costs when operating the combination. If a CO₂-neutral primary energy source is used, the CO₂ load in the production of corrugated paperboard will be reduced correspondingly.

In order to ensure the most cost-effective operation of the installation, it is designed such that as many simultaneous consumers as possible are available for the thermal and electrical power of the thermal engine (demand simultaneity factor). This is particularly optimally the case in the combination of corrugator and printing installation described here, so that not only a cost-effective but also a possible CO₂-neutral method of energy supply is available. However, even when fossil natural gas is used in the thermal engine, there is a significant reduction in power-comparable CO₂ emissions.

Preferably, the thermal engine provides the thermal power in the form of a hot gas, of which a first hot gas portion is used in the printing installation, in particular directly for drying the paper ply and/or the print, and a second hot gas portion is used for generating process steam for the corrugator. In the case of a gas turbine, the hot gas is a flue gas that is generated during the combustion of the primary energy source. This flue gas has a temperature in the range of 500° C. to 600° C. The thermal power of the thermal engine is therefore used in two different ways, i.e. the installation is a bivalent system in this respect: on the one hand, the hot gas in the printing installation is used directly for drying (direct heat utilization) and on the other for the simultaneous generation of process steam for the corrugator (indirect heat utilization). Downstream of the thermal engine, the hot gas stream is divided into two partial streams, one of which is fed to the printing installation, the other to a waste heat boiler which is used for generating process steam for the corrugator, in particular by means of the sensible heat in the waste heat boiler.

The first hot gas portion is preferably at least partially fed to a pre-dryer of the printing installation for drying the paper ply before printing, in particular for preconditioning the paper web for a more stable process. Alternatively or additionally, the first hot gas portion is at least partially fed to a hot air dryer of the printing installation for drying the print, i.e. for drying after printing. The pre-dryer and the hot air dryer are generally also referred to as dryers. The dryers are preferably designed as convection dryers, i.e. they emit warm drying air which comes into direct contact with the paper ply and, if applicable, the print (direct gas drying). The hot gas from the thermal engine is particularly suitable for such direct, thermal convection drying in the printing installation, since the hot gas is, by its nature, free of particles or similar pollutants. The hot gas is also sterile and contains mainly CO₂, N₂ and water vapor. This direct gas drying process advantageously does not require a heat exchanger, which would create heat transfer losses; such a heat exchanger is conveniently dispensed with. A further advantage of direct gas use is that an internal recirculation operation can be dispensed with for reasons of energy efficiency and is also expediently dispensed with. In the circulating air, the water vapor partial pressure and relative humidity would increase, which would fundamentally inhibit the drying/evaporation of solvents in the print. By dispensing with recirculation operation in the dryers, complex piping systems and radial fans for the supply and circulating air are also eliminated. Furthermore, the drying air has an almost constant moisture content, which has a positive effect on the drying characteristics of the print.

Preferably, the printing in the printing installation is based on an inkjet process. In particular, the printing installation expediently uses exclusively one or more water-based inks to print on the paper ply. This avoids flammable solvent mixtures in combination with the hot gas, which contributes to explosion protection.

The temperature of the respective drying air, i.e. the drying temperature, in the respective dryer is in particular adjustable and is expediently set in the range of 100° C. to 600° C. as required. Preferably, the drying temperature is adjusted by adding fresh air. In a preferred embodiment, the drying temperature in the hot air dryer is controlled or even regulated as a function of a conveying speed of the paper ply through the printing installation. The idea behind this is that when the conveying speed changes, the period of time over which the paper ply and the print are in contact with the drying air also changes. In order to ensure a consistent drying result, the drying temperature is then appropriately adjusted, i.e. reduced in the case of lower conveying speeds and conversely increased in the case of higher conveying speeds.

In a suitable embodiment, an exhaust air stream from the hot air dryer is fed to the pre-dryer for drying the paper ply before printing. The drying air is directed onto the paper ply in the hot air dryer and then discharged as an exhaust air stream. Since the drying air may not transfer all of its heat to the paper ply with the print, the exhaust air stream contains a corresponding residual heat (e.g. a temperature in the range of 100° C. to 200° C.), which is then used in the pre-dryer. Alternatively or additionally, depending on its temperature, the exhaust air stream of the hot air dryer is expediently used either in an exhaust air recuperator (in particular air/air recuperator) at a high temperature, in particular in the range of 200° C. to 400° C. and/or to generate process cooling, e.g. in an absorption chiller, at a low temperature, in particular in the range of 100° C. to 200° C. The same applies analogously to a corresponding exhaust air stream of the pre-dryer, if one is present.

In addition to the first hot gas portion for direct gas utilization, the second hot gas portion is fed in particular to the aforementioned waste heat boiler (also referred to as a partial stream waste heat boiler), suitably via a regulated hot gas bypass, which is designed, for example, with a valve for dividing the hot gas into the two hot gas portions (the valve then “bypasses” direct gas utilization and the hot gas is fed to the waste heat boiler instead, or vice versa). The distribution of the hot gas between the two hot gas portions, i.e. a ratio of the first to the second hot gas portion, is conveniently regulated, in particular by means of the hot gas bypass. Appropriately, regulation is based on the medium with the highest added value. This is in particular the process steam. When the installation is put into operation, it is advisable to measure the maximum volume flow of hot gas (first hot gas portion) that must be diverted for direct gas use for drying in the printing installation. The remaining hot gas is fed to the waste heat boiler (second hot gas portion). The design is carried out within the framework of a process balancing. The thermal engine is then designed correspondingly in terms of the power ratio. If the respective thermal power requirement of the corrugator and of the printing installation fluctuates, the distribution of the hot gas between the first and the second hot gas portions is preferably regulated such that the corrugator in particular is always supplied with sufficient thermal power and thus has priority over the supply of thermal power to the printing installation. In other words, priority is given to the thermal power requirement of the corrugator and this therefore takes precedence over the thermal power requirement of the printing installation. A possible deficit in the supply of thermal power to the printing installation is suitably compensated for by supplying additional thermal power which is generated separately from the thermal power of the thermal engine, in particular by means of a heating element, e.g. a gas burner or an electrical heating register or the like. This has the advantage that electrical power from the thermal engine is used, which may already be available with a slight surplus. The corrugator's need for process steam therefore has overall priority, i.e. if more power is suddenly required for generating process steam, the first hot gas portion is reduced accordingly compared to the second hot gas portion, i.e. less hot gas is fed to the printing installation for drying. The reduction of the first hot gas portion is suitably compensated for by additional thermal power as described.

In principle, it is advantageous to feed the hot gas for direct air drying to one or more dryers in a continuous operation and to discharge it therefrom as exhaust air and, if necessary, to use any residual heat elsewhere. However, a variant in which one or more dryers of the printing installation are operated at least temporarily or even permanently in recirculation operation is also advantageous, i.e. the hot gas fed is not simply passed through and then discharged as exhaust air, but is continuously circulated, at least partially. Recirculation operation is particularly advantageous if, as described above, a deficit in thermal power for the printing installation is compensated for by supplying additional thermal power by means of a heating element (e.g. gas burner, electrical heating register or the like). Recirculation operation thus advantageously reduces the hot gas stream supplied, since the circulating air temperature, which cools down due to heat loss, only needs to be kept constant. Overall, at least the following two variants are advantageous. In a first variant, drying takes place in continuous operation. Compared to recirculation operation, the required hot gas stream is greater but the required temperature is lower, since the volume flow must be comparatively large in order to achieve a certain required discharge velocity at the outlet (e.g. dryer nozzles) of the dryer (in recirculation operation this is achieved with a separate recirculation fan). In a second variant, partial recirculation operation (mixed operation) is used. Compared to continuous operation, the required hot gas stream is now significantly lower, but the temperature must be higher to compensate for the heat losses from recirculation operation. In particular, the heating element is only used for compensation in the event of the aforementioned deficit and then represents a backup solution to compensate as required for any peaks in thermal power requirements.

In an advantageous embodiment, however, recirculation operation is used alternatively or additionally in a different way as follows: since the hot gas from the thermal engine regularly has a significantly higher temperature than is required for drying, this hot gas can also be used in recirculation operation for a certain period of time or even permanently before the temperature has dropped below a minimum temperature required for drying. In an advantageous embodiment, at least part of the hot gas from the thermal engine is fed to a hot air dryer (preferably the hot air dryer already mentioned above) of the printing installation and the hot air dryer is then operated in recirculation operation. The minimum temperature is in particular a temperature required at least for drying and is preferably in the range of 200° C. to 300° C. In contrast, the hot gas from the thermal engine has a significantly higher temperature, preferably in the range of 500° C. to 600° C. or is 200° C. to 400° C. hotter than the minimum temperature, so that a correspondingly large amount of heat is available for use in recirculation operation. When the temperature of the hot gas in the hot air dryer reaches the minimum temperature, the now “used” hot gas is discharged as exhaust air and the process is started again from the beginning as required.

Partial recirculation operation (also known as mixed operation) is also suitable as recirculation operation, in which only part of the hot gas is circulated in the hot air dryer and another part is discharged as exhaust air and then expediently replaced by fresh hot gas. 100% (completely closed) recirculation operation is typically not possible at all, as this would concentrate solvents (mainly water vapor) in the circulating air. For this reason, in recirculation operation, cold, unpolluted fresh air is expediently supplied and hot, polluted exhaust air is removed, but both volume flows are kept as low as possible. Preferably, when there is too little hot gas available for drying in the printing installation, the installation is switched to partial recirculation operation. In this mode, additional heating elements such as gas burners etc. in the circulating air can be used and are preferably used, which would not be possible with direct continuous drying.

The waste heat boiler generates saturated steam, e.g. at 16 bar, and thus advantageously serves the complete process steam requirement of the corrugator and thus in particular also its complete thermal power requirement. This second part of the bivalent heat utilization significantly increases the overall efficiency of the installation.

The process steam for the corrugator is suitably first fed from the waste heat boiler to a steam distributor, which then forwards the process steam at a suitable pressure to a respective processing station of the corrugator. The corrugator has in particular one or more of the following processing stations: a preheater, for preheating one or more paper plies, e.g. before gluing; a laminating unit and/or a heating and traction section, in each case for gluing a plurality of paper plies together; a module facer (e.g. with corrugating roller), for corrugating a paper ply. One or more of the aforementioned processing stations have a heating device and/or a humidification device which require process steam, e.g. a heating plate or a spray bar.

As has already been indicated, the thermal power requirement of the combination may vary depending on the current production order. The installation therefore suitably has a steam accumulator, which compensates for the time-variable thermal power requirement of the combination. In other words, the thermal engine generates a predominantly constant amount of thermal and electrical power, whereas the combination can have a varying thermal and electrical power requirement depending on the production order. Any surplus thermal power is then diverted to the steam accumulator or, conversely, thermal power is taken therefrom if the thermal power requirement of the combination exceeds the thermal power of the thermal engine (with regard to electrical power, an analogous procedure is used, for example, using the public grid instead of the steam accumulator). Hot gas (more precisely, hot gas from the second hot gas stream) from the thermal engine is stored in the steam accumulator and is retrieved when required for the printing installation or the corrugator or both. In a practical design, hot water or superheated steam is extracted from the waste heat boiler or from the steam accumulator when required and used to generate process cooling. In an advantageous embodiment, the superheated steam is used as saturated steam for re-moistening and/or for adjusting a wet cross-profile in the printing installation.

In a suitable embodiment, the ratio of the thermal powers of the first and second hot gas portions is 3:4 to 1:4, i.e. the larger part of the thermal power is fed to the waste heat boiler and/or the steam accumulator and used in particular as process steam for the corrugator, while only approximately 20% to 45% of the thermal power is used for the printing installation. For example, the thermal power of direct gas utilization (first hot gas stream) is 1.6 MW and the remaining thermal power (second hot gas stream) is 2.5 MW, which corresponds to a ratio of approximately 2:3.

In an advantageous embodiment, the installation is designed to generate process cooling and for this purpose has in particular an absorption chiller and/or a compression chiller. The process cooling is expediently used to cool one or more components of the printing installation and/or of the corrugator, e.g. to operate a cooling roller for cooling the paper ply in the printing installation. The process cooling is supplied, for example, by means of cooling water, which is cooled by an absorption chiller and/or a compression chiller.

The absorption chiller is operated with thermal power, e.g. as described above with an exhaust air stream from the printing installation or with hot water or superheated steam from the waste heat boiler or the steam accumulator or directly with hot gas from the thermal engine. The compression chiller, on the other hand, is operated with electrical power, which in particular comes directly from the thermal engine. Accordingly, process cooling can be generated flexibly in different ways depending on the supply of thermal and electrical power. Accordingly, in an advantageous embodiment for generating process cooling, the installation has not only an absorption chiller, which is operated with thermal power, but also a compression chiller, which is operated with electrical power, and a respective power consumption of the absorption chiller and the compression chiller is controlled such that the thermal power requirement and the electrical power requirement of the combination are adapted as optimally as possible to the electrical power and the thermal power of the thermal engine. In other words, a given amount of process cooling is generated proportionally by means of the absorption chiller and the compression chiller such that the thermal and electrical power of the thermal engine is used as optimally as possible. The power consumption of the absorption chiller and of the compression chiller is therefore controlled depending on which type of power is still available at a given time, so that the power requirement ratio of the combination as a whole is optimized. The underlying consideration is that the way in which process cooling is generated is irrelevant for its use. If, for example, no thermal power is available at a given time for generating process cooling but electrical power is available, the process cooling is generated by means of the compression chiller. Conversely, if there is a surplus of thermal power, process cooling is generated by means of the absorption chiller. The amount of process cooling generated preferably remains constant. Mixed operation is also possible and advantageous depending on the respective power supply.

As long as a sufficient amount of thermal power is available, the absorption chiller is preferably operated as a flow-through cooler, which is designed for the highest possible number of operating hours. The compression chiller is preferably only activated to cover a peak cooling load and otherwise remains inactive. The compression chiller is therefore a type of emergency unit and is only activated in exceptional cases in order to serve a peak load, while the absorption chiller primarily serves a base load continuously.

Like the thermal power, the electrical power of the thermal engine is also used not only by the printing installation but also by the corrugator. In a preferred embodiment, the electrical power is used to operate at least one IR dryer (i.e. infrared dryer) of the printing installation, at least one drive of the printing installation and/or of the corrugator (i.e. for conveying one or more paper plies, the corrugated paperboard or intermediate products thereof) and at least one processing station, e.g. a wet end or a dry end of the corrugator. The dry end preferably has one or more of the following processing stations: cross-cutter, longitudinal cutter, slitting device, creasing device. The dry end is connected to the wet end of the corrugator and refers to the part of the corrugator to which the paper plies joined to form a corrugated paperboard web are fed for further processing, in particular assembly, i.e. the paper plies are no longer present individually in the dry end but are connected to form the corrugated paperboard web.

The IR dryer in the printing installation is used primarily for drying the print. Compared to convection drying, an IR dryer has the advantage that it does not blur the still fresh print image. For this reason, an IR dryer is preferably arranged immediately downstream of a print head of the printing installation. The disadvantages of an IR dryer, however, are its high electrical power requirements (regularly in the range of approx. 500 KW to 1000 KW), its relatively short lifespan (limited lifespan of carbon filaments, for example) and the fact that the effectiveness of the drying depends on the absorption coefficient of the printed ink and is therefore sometimes color-dependent. In order to eliminate the aforementioned disadvantages of an IR dryer and to integrate an additional heat sink into the installation, it is advantageous to combine an IR dryer with a hot air dryer in the printing installation. Instead of using an IR dryer exclusively for drying, it is dimensioned smaller and combined with a hot air dryer in order to achieve at least the required drying performance. In an advantageous embodiment, the printing installation therefore has at least one IR dryer and at least one hot air dryer (in particular as already described above) for drying the print, and the IR dryer is arranged upstream of the hot air dryer with respect to a conveying direction of the paper ply that is being printed on. In this way, the print is pre-dried using the IR dryer before the necessary remaining drying is carried out using the hot air dryer. Pre-drying with the IR dryer advantageously prevents the print from smudging during drying in the hot air dryer. The hot air dryer also reduces the electrical power requirements of the printing installation and requires less maintenance than the IR dryer.

Preferably, the printing installation has at least two IR dryers, namely a first IR dryer upstream and a second IR dryer downstream (with respect to the conveying direction of the paper ply) of the hot air dryer.

Analogous to the combination of absorption chiller and compression chiller for generating process cooling, the combination of IR dryer and dryer also advantageously allows an optimization of the power requirement ratio of the combination and thus an adaptation of the thermal and electrical power requirement to the actually available thermal and electrical power, if necessary also in response to a change in operation, e.g. due to a change in the production order for the installation. The above statements on the generation of process cooling also apply analogously to drying and vice versa. In an advantageous embodiment, the printing installation for drying the print has an IR dryer which is operated with electrical power, and a dryer (hot air dryer) which is operated with thermal power. The IR dryer and the dryer preferably correspond to the IR dryer and hot air dryer described above. The respective power consumption of the IR dryer and of the dryer is now controlled such that a thermal power requirement and an electrical power requirement of the combination are adapted to the electrical power and the thermal power of the thermal engine. For example, in the case of a surplus of thermal power, the power requirement of the dryer is increased and the power requirement of the IR dryer is reduced (and vice versa in the case of a surplus of electrical power), suitably such that the drying performance of the combination of dryer and IR dryer remains constant. Analogous to the combination of absorption chiller and compression chiller, a design is also advantageous in which one of the dryers, in particular the hot air dryer, serves a base load in terms of drying and the other dryer, in particular the IR dryer, only serves a peak load when required. In detail, however, the control of the different dryers depends on the design of the entire installation (number, type and performance of the various dryers) and on the process balancing (distribution of thermal and electrical power between the corrugator and the printing installation).

A preferred embodiment of the installation is described below in summary for illustration purposes. A paper ply is fed to the printing installation, e.g. from a dispenser. The paper ply is first optionally pre-dried by means of a pre-dryer. The paper ply is then printed by means of a number of print heads, i.e. provided with a print, which is then dried first using an IR dryer and then using a hot air dryer. This can optionally be followed by another IR dryer as a booster in order to achieve a particularly high drying performance overall, e.g. at a particularly high conveying speed. The printed and dried paper ply is finally cooled by means of one or more cooling rollers and then transferred directly to the corrugator. In this process, the paper ply is bonded to other paper plies in the wet end to form a corrugated paperboard web and then, if necessary, assembled in the dry end. The assembled corrugated paperboard is then output from the corrugator either as a continuous product or as multiple panels. The thermal power of the thermal engine is divided between the pre-dryer and the hot air dryer on the one hand and a waste heat boiler and optionally also a steam accumulator on the other. The waste heat boiler supplies various processing stations of the corrugator with process steam for joining the paper plies to form corrugated paperboard. Optionally, part of the thermal power and/or one or more exhaust air streams of the printing installation are used to generate process cooling and/or fed to an exhaust air recuperator for preheating fresh air for the thermal engine. The cooled, but still warm exhaust air from the exhaust air recuperator is used, for example, to generate process cooling. The electrical power of the thermal engine is distributed between the IR dryers of the printing installation and one or more drive units of the printing installation and the corrugator. In addition, the dry end is supplied with electrical energy in order to process the corrugated paperboard web, e.g. by cutting and/or creasing. Surplus electrical power is fed into the public grid if necessary.

In the following, exemplary embodiments of the invention are explained in more detail with reference to a drawing. In the drawing:

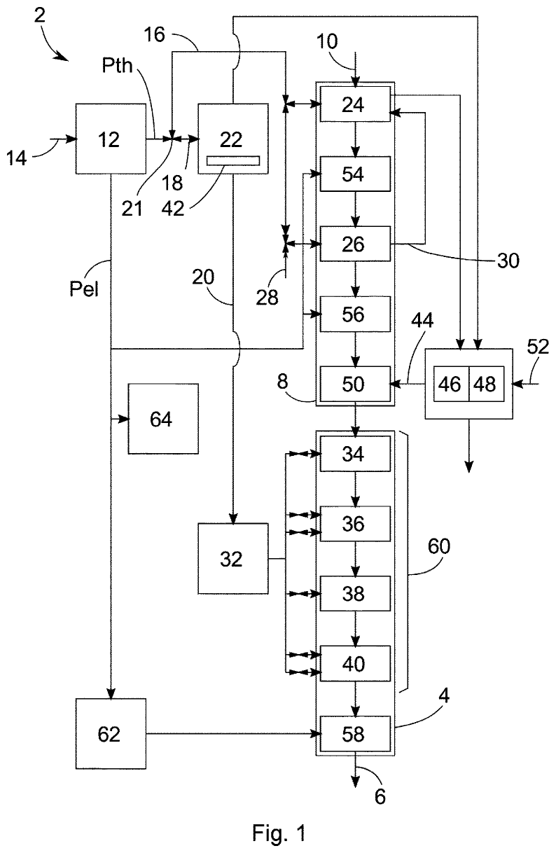

FIG. 1 schematically shows a process diagram for the operation of an installation,

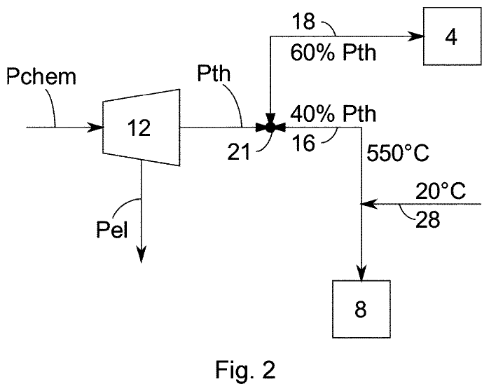

FIG. 2 schematically shows process balancing for the installation from FIG. 1.

The installation 2 shown in FIG. 1 has a corrugator 4 for producing corrugated paperboard 6, which is produced, for example, as a continuous corrugated paperboard web or as a ready-made panel. In addition, the installation 2 has a printing installation 8, here a digital printing installation, with a number of print heads (not explicitly shown) for printing a print on a paper ply 10. In the embodiment shown here, an in-line operation is implemented in which the printed paper ply 10 is transferred from the printing installation 8 directly to the corrugator 4 in order to use the paper ply 10 in the production of the corrugated paperboard 6. In an alternative embodiment not explicitly shown, the printing installation 8 and the corrugator 4 are operated separately from one another and the printing installation 8 is operated, for example, in a roll-to-roll operation. Regardless of whether the printing installation 8 and the corrugator 4 are operated in-line or separately, they are always operated simultaneously.

In the exemplary embodiment shown, printing takes place before the paper ply 10 is combined with other paper plies to form the corrugated paperboard 6. Overall, the installation 2 is used to produce printed corrugated paperboard 6. The printing installation 8 and the corrugator 4 are operated in-line, i.e. the paper ply 10 that is to be printed on passes through the printing installation 8 and the corrugator 4 without being wound up and unwound in between. If the paper ply 10 is not used to produce corrugated paperboard 6 with the corrugator 4, the installation 2 is in any case used to produce a printed paper ply 10 on the one hand and corrugated paperboard 6 on the other.

The installation 2 further comprises a thermal engine 12 for generating thermal power Pth and electrical power Pel from a supplied chemical power Pchem. In the embodiment shown, the thermal engine 12 has a gas turbine (not explicitly shown) and a generator (also not explicitly shown). The gas turbine is operated with gas as the primary energy source 14.

The corrugator 4 and the printing installation 8 now form a combination and are thus jointly supplied with thermal power Pth and electrical power Pel by the thermal engine 12, i.e. the thermal and electrical power Pth, Pel generated by the thermal engine 12 are distributed between the corrugator 6 and the printing installation 8, which each consume both thermal and electrical power. A possible process balancing for the distribution of thermal and electrical power Pth, Pel is shown in FIG. 2. In the exemplary embodiment in FIG. 2, the electrical power Pel is 1.9 MW and the thermal power Pth is 4.1 MW, so that the power ratio of the thermal engine 12 is approximately 2:1. The thermal power Pth is then divided, for example, between the printing installation 8 and the corrugator 6 in a ratio of 2:3, with the corrugator 6 receiving the larger share. However, the values and ratios specified may vary depending on the specific design of the entire installation 2.

The thermal engine 12 shown here provides the thermal power Pth in the form of a hot gas at, for example, 550° C., of which a first hot gas portion 16 is used directly in the printing installation 8 for drying the paper ply 10 and/or the print. A second hot gas portion 18 of the hot gas is used to generate process steam 20 for the corrugator 6. The thermal power Pth is used in two different ways, namely on the one hand for drying in the printing installation 8 (direct heat utilization) and on the other hand for the simultaneous generation of process steam for the corrugator 4 (indirect heat utilization). Downstream of the thermal engine 12, the hot gas stream is divided into the two partial streams 16, 18 by a hot gas bypass 21 (implemented here with a valve); one is fed to the printing installation 8, the other to a waste heat boiler 22, with which the process steam 20 for the corrugator 4 is generated.

The first hot gas portion 16 is partially fed to a pre-dryer 24 for drying the paper ply 10 before printing. In addition, in FIG. 1, the first hot gas portion 16 is also partially fed to a hot air dryer 26 for drying the print, i.e. for drying after printing. The pre-dryer 24 and the hot air dryer 26 are each generally referred to as dryers. The dryers 24, 26 are each designed as convection dryers, i.e. they emit warm drying air which comes into direct contact with the paper ply 10 and, if applicable, the print (direct gas drying). The temperature of the respective drying air, i.e. the drying temperature, in the respective dryer 24, 26 is adjustable and in the exemplary embodiment shown is set as required in the range of 100° C. to 600° C., in this case by adding fresh air 28, e.g. with a temperature of 20° C.

The following calculation example is intended to roughly illustrate the design of the installation 2: the thermal engine 12 provides hot gas with a mass flow in the range of 5 to 10 kg/s, which is distributed between the printing installation 8 and the corrugator 6 in a ratio of approximately 2:3, as shown in FIG. 2. With a knowledge of the temperature of the hot gas, the corresponding volume flow can be calculated and distributed among the various tasks, including in particular the dryers 24, 26. The volume flow for the printing installation 8 and its temperature are adjusted via the fresh air 28, which is dimensioned according to the specific requirements. For example, the temperature selected for the dryers 24, 26 is approximately half the hot gas temperature, and the first hot gas portion 16 is mixed with fresh air 28 in a ratio of approximately 3:1 (volume flow ratio) to obtain a sufficient amount of hot air with a sufficient temperature for drying.

In addition, in FIG. 1, an exhaust air stream 30 of the hot air dryer 26 is fed to the pre-dryer 24 for drying the paper ply 10 before printing. The drying air is directed onto the paper ply in the hot air dryer and then discharged as an exhaust air stream 30. Alternatively or additionally, the exhaust air stream 30 is used in an embodiment not shown, depending on its temperature, either in an exhaust air recuperator and/or to generate process cooling 44. The same applies analogously to a corresponding exhaust air stream from the pre-dryer 24, if such is present.

In addition to the first hot gas portion 16 for direct gas use, the second hot gas portion 18 is fed to the waste heat boiler 22. This generates saturated steam and thus serves the entire process steam requirement of the corrugator 4. The process steam 20 for the corrugator 4 is first fed from the waste heat boiler 22 to a steam distributor 32, which then forwards the process steam 20 at a suitable pressure to a respective processing station of the corrugator 4. The corrugator 4 shown here as an example has the following processing stations: a preheater 34 for preheating one or more paper plies; a module facer 36 for corrugating a paper ply; a laminating unit 38 and a heating and traction section 40, in each case for bonding a plurality of paper plies together.

Depending on the current production order, the thermal power requirement of the combination may vary. For this reason, the installation 2 in FIG. 1 additionally has a steam accumulator 42, which compensates for the time-variable thermal power requirement of the combination. Hot gas is stored in the steam accumulator 42 and is retrieved when required. In the embodiment shown here, hot water or superheated steam is even extracted from the waste heat boiler 22 or from the steam accumulator 42 when required and used to generate process cooling 44. In an advantageous embodiment, the superheated steam is used as saturated steam for re-moistening and/or for adjusting a wet cross-profile in the printing installation.

As already indicated, the installation 2 shown here is designed to generate process cooling 44 and for this purpose has an absorption chiller 46 and a compression chiller 48. The process cooling 44 is used to cool one or more components of the printing installation 8 and/or of the corrugator 4, in FIG. 1 specifically to operate a cooling roller 50 for cooling the paper ply 10 in the printing installation 8. The process cooling 44 is supplied, for example, by means of cooling water 52, which is cooled by the absorption chiller 46 and the compression chiller 48.

The absorption chiller 46 is operated with thermal power Pth, while the compression chiller 48 is operated with electrical power Pel. Accordingly, process cooling 44 can be flexibly generated in different ways depending on the supply of thermal and electrical power Pth, Pel. Accordingly, in the present case, a respective power consumption of the absorption chiller 46 and of the compression chiller 48 is controlled such that the thermal power requirement and the electrical power requirement of the combination are adapted as optimally as possible to the electrical power Pel and the thermal power Pth of the thermal engine 12. The power consumption of the absorption chiller 46 and of the compression chiller 48 is therefore controlled depending on which type of power Pth, Pel is available at a given time, so that the power requirement ratio of the combination as a whole is optimized.

Like the thermal power Pth, the electrical power Pel is used by both the printing installation 8 and the corrugator 4. In the exemplary embodiment shown, the electrical power Pel is used to operate two IR dryers 54, 56 (i.e. infrared dryers) of the printing installation 8 and to operate a respective drive 62 of the printing installation 8 and of the corrugator 4 and also to operate at least one processing station of a dry end 58 of the corrugator 4. The dry end 58 has one or more of the following processing stations: cross-cutter, longitudinal cutter, slitting device, creasing device. For the sake of simplicity, these are not explicitly shown here. The dry end 58 is connected to the wet end 60 of the corrugator 4.

The IR dryer 54 is arranged immediately downstream of a print head of the printing installation 8. This is combined in the printing installation 8 with the hot air dryer 26 as an additional heat sink. The IR dryer 54 is arranged upstream of the hot air dryer 26 with respect to a conveying direction of the paper ply 10 that is being printed on, as shown in FIG. 1. In this way, the print is pre-dried using the IR dryer 54 before the remaining drying is carried out using the hot air dryer 26. In addition, the printing installation 8 shown here also has the second IR dryer 56 downstream of the hot air dryer 26.

Analogously to the combination of absorption chiller 46 and compression chiller 48 for generating process cooling 44, the combination of IR dryer 54, 56 and dryer 24, 26 also allows an optimization of the power requirement ratio of the combination and thus an adaptation of the thermal and electrical power requirement to the actually available thermal and electrical power Pth, Pel. The statements regarding the generation of process cooling 44 also apply analogously to drying and vice versa. A respective power consumption of the IR dryers 54, 56 and of the dryers 24, 26 is now controlled such that a thermal power requirement and an electrical power requirement of the combination are adapted to the electrical power Pel and the thermal power Pth of the thermal engine 12.

Surplus electrical power Pel is fed into the public grid 64 if necessary.

### LIST OF REFERENCE SIGNS

2 Installation
4 Corrugator
6 Corrugated paperboard
8 Printing installation
10 Paper ply
12 Thermal engine
14 Primary energy source
16 First hot gas portion
18 Second hot gas portion
20 Process steam
22 Waste heat boiler
24 Pre-dryer, dryer
26 Hot air dryer, dryer
28 Fresh air
30 Exhaust air stream
32 Steam distributor
34 Preheater
36 Module facer
38 Laminating unit
40 Heating and traction section
42 Steam accumulator
44 Process cooling
46 Absorption chiller
48 Compression chiller
50 Cooling roller
52 Cooling water
54 IR dryer
56 IR dryer
58 Dry end
60 Wet end
62 Public grid
Pchem Chemical power
Pel Electrical power
Pth Thermal power

1. A method for operating an installation, the method comprising:
(a) producing corrugated paperboard, using a corrugator of the installation;
(b) printing a print on a paper ply, using a printing installation of the installation; and
(c) generating thermal power (Pth) and electrical power (Pel) using a thermal engine of the installation,
wherein the corrugator and the printing installation form a combination and are thus jointly supplied with thermal power (Pth) and with electrical power (Pel) by the thermal engine.

2. The method according to claim 1,
wherein the thermal engine provides the thermal power (Pth) in the form of a hot gas, of which a first hot gas portion is used in the printing installation for drying and a second hot gas portion is used for generating process steam for the corrugator.

3. The method according to claim 2,
wherein, if a respective thermal power requirement of the corrugator and the printing installation fluctuates, the distribution of the hot gas between the first and the second hot gas portion is regulated such that the corrugator is supplied with sufficient thermal power (Pth) and thus has priority over the supply of thermal power (Pth) to the printing installation,
wherein a possible deficit in the supply of thermal power to the printing installation is compensated for by supplying additional thermal power which is generated separately from the thermal power (Pth) of the thermal engine.

4. The method according to claim 2,
wherein the first hot gas portion is at least partially fed to a pre-dryer of the printing installation for drying the paper ply before printing.

5. The method according to claim 4,
wherein the first hot gas portion is at least partially fed to a hot air dryer of the printing installation for drying the print.

6. The method according to claim 5,
wherein an exhaust air stream from the hot air dryer is fed to the pre-dryer.

7. The method according to claim 5,
wherein a drying temperature in the hot air dryer is controlled depending on a conveying speed of the paper ply through the printing installation.

8. The method according to claim 2,
wherein at least a part of the hot gas from the thermal engine is fed to a hot air dryer of the printing installation and the hot air dryer is then operated in recirculation operation.

9. The method according to claim 1,
wherein the installation has a steam accumulator which compensates for the time-variable thermal power requirement of the combination.

10. The method according to claim 1,
further comprising an installation for generating process cooling having an absorption chiller which is operated with thermal power (Pth) and a compression chiller which is operated with electrical power (Pel),
wherein a respective power consumption of the absorption chiller and of the compression chiller is controlled such that a thermal power requirement and an electrical power requirement of the combination are adapted to the electrical power (Pel) and the thermal power (Pth) of the thermal engine.

11. The method according to claim 1,
wherein the electrical power (Pel) is used to operate
at least one IR dryer of the printing installation,
at least one drive of the printing installation and/or of the corrugator, and
at least one processing station of the corrugator.

12. The method according to claim 11,
wherein the printing installation has at least one IR dryer and at least one hot air dryer for drying the print,
wherein the IR dryer is arranged upstream of the hot air dryer with respect to a conveying direction of the paper ply.

13. The method according to claim 12,
wherein the printing installation has an IR dryer which is operated with electrical power (Pel) and a dryer which is operated with thermal power (Pth) for drying the print,
wherein a respective power consumption of the IR dryer and of the dryer is controlled such that a thermal power requirement and an electrical power requirement of the combination are adapted to the electrical power (Pel) and the thermal power (Pth) of the thermal engine.

14. The method according to claim 1,
wherein the thermal engine has a gas turbine.

15. The method according to claim 1,
wherein the printing installation is a digital printing installation.

16. The method according to claim 1,
wherein the printing installation and the corrugator are operated in-line.

17. The method according to claim 1,
wherein the printing installation and the corrugator are operated separately from one another,
wherein the printing installation and/or the corrugator is/are operated in particular in a roll-to-roll operation and/or a roll-to-sheet operation.

18. An installation which is designed to operate in accordance with a method according to claim 1.
